(19) United States
(12) Patent Application Publication
(10) Pub. No.: US 2025/0375010 A1
(43) Pub. Date: Dec. 11, 2025

(54) CARD HOLDER

(71) Applicant: TITAN STAR TRADING LIMITED, Hong Kong (CN)

(72) Inventors: JunHao CHEN, Guangzhou (CN); RunHong GONG, Guangzhou (CN)

(73) Assignee: TITAN STAR TRADING LIMITED, Hong Kong (CN)

(21) Appl. No.: 19/150,956

(22) PCT Filed: Nov. 24, 2023
(86) PCT No.: PCT/CN2023/133982

§ 371 Date: Jul. 25, 2025

(30) Foreign Application Priority Data
Nov. 28, 2022 (CN) 202223161792.X

(51) Int. Cl. A45C 11/18

(52) U.S. Cl. CPC A45C 11/182

(57) ABSTRACT

A card holder includes a case, inside which a space for stacking a card is formed; a base connected to a bottom end of the case, a through hole being formed in one side of the base; a pushing member configured to be slidably assembled to the base via the through hole; an elastic element capable of exerting a force to reset the pushing member in a sliding direction thereof; a stepped component hinged to the pushing member at one end thereof, a step cooperating with the card being arranged on the other end of the stepped component, a chute being arranged in a middle of the stepped component and throughout a direction perpendicular to the sliding direction; a first shaft passing through an interior of the chute and fixed to the base.

### TECHNICAL FIELD

The present disclosure relates to the technical field of wallets, and in particular, to a card holder.

### BACKGROUND

The card holder is configured to store multiple cards, such as bank cards, access cards, ID cards and so on. The card holder can push out multiple cards through a card pusher. In a related art, a force-applying mechanism of the card pusher will wear, deform and even break after being pushed and used repeatedly, causing problems such as jamming and increased resistance of the force-applying mechanism, such that the force-applying mechanism cannot push the card out, and the card holder has a card pop-up fault.

### SUMMARY

The present disclosure aims to solve at least one of the technical problems existing in the existing technology. To this end, the present disclosure provides a card holder which has a stable and reliable pushing process, a pushing member with less wear, and a more durable structure.

In accordance with an embodiment of the present disclosure, the card holder includes: a case, a space for stacking one or more cards being formed inside the case; a base connected to a bottom end of the case, a through hole being formed in one side of the base; a pushing member configured to be slidably assembled to the base via the through hole; an elastic element capable of exerting a force to reset the pushing member in a sliding direction thereof; a stepped component hinged to the pushing member at one end of the stepped component, a step being arranged on the other end of the stepped component, and a chute being arranged in a middle of the stepped component; and a first shaft passing through the chute and fixed to the base; where in response to the pushing member sliding toward an interior of the base, the stepped component rotates around the pushing member, and the chute slides relative to the first shaft, such that the step pushes one or more cards out of a top end of the case.

In accordance with an embodiment of the present disclosure, the card holder has at least the following beneficial effects.

The pushing member is slidably assembled to the base via the through hole in one side of the base, and the elastic element can exert the force to reset the pushing member in the sliding direction thereof. One end of the stepped component is hinged to the pushing member, the step cooperating with the card is arranged at the other end of the stepped component. The base is connected to the bottom end of the case on which the cards are stacked, and the first shaft passing through the chute of the stepped component is fixed to the base. In response to the pushing member sliding toward the interior of the base, the stepped component can rotate around the pushing member, and the chute slides relative to the first shaft, such that the step pushes one or more cards out of the top end of the case. A movement cooperation of the pushing member, the stepped component and the base is stable and reliable, thereby reducing the wear of the pushing member in the sliding process and improving the durability of the card holder.

In accordance with some embodiments of the present disclosure, the stepped component includes a first arm and a second arm which are connected to each other and form an obtuse angle. The first arm is hinged to the pushing member at one end thereof, and has the chute at the other end thereof. The chute extends in a length direction of the first arm. The second arm is connected to the first arm at one end thereof, and has the step at the other end thereof.

In accordance with some embodiments of the present disclosure, the pushing member has a limiting mechanism configured to abut against and cooperate with the first arm to limit a terminal angle of a rotation of the stepped component around the pushing member.

In accordance with some embodiments of the present disclosure, the limiting mechanism is a blocking plate arranged inside the pushing member. A hinge between the stepped component and the pushing member is spaced apart from the blocking plate, and the blocking plate is located on one side of the hinge that is away from the elastic element.

In accordance with some embodiments of the present disclosure, the stepped component has a mounting hole, and the pushing member has a second shaft passing through the mounting hole, such that the stepped component is hinged to the pushing member.

In accordance with some embodiments of the present disclosure, the elastic element is a torsion spring which includes a first torsion arm fixed to the pushing member and a second torsion arm fixed to a side wall of the base that is away from one side of the through hole.

In accordance with some embodiments of the present disclosure, the first torsion arm has a first bending portion at an end thereof, and the pushing member has a support lug into which the first bending portion is plugged. The pushing member also has a first baffle, and the first torsion arm is clamped between the first baffle and the support lug.

In accordance with some embodiments of the present disclosure, the second torsion arm has a second bending portion at an end thereof, and the base has a second baffle with a notch through which the second torsion arm passes, such that the second bending portion is clamped between the second baffle and a bottom wall of the base.

In accordance with some embodiments of the present disclosure, the base includes a bottom wall, a front side wall and a rear side wall. Each of an inner wall surface of the bottom wall, an inner wall surface of the front side wall and an inner wall surface of the rear side wall has a rib extending in a sliding direction of the pushing member, and the base is slidably connected to an outer wall surface of the pushing member through the ribs.

In accordance with some embodiments of the present disclosure, a support table is arranged at a top end of the base, and front and rear sides of the step abut against and cooperate with the support table, respectively.

In accordance with some embodiments of the present disclosure, the support table has a positioning edge along a circumference thereof, and the inner wall surface of the case has a positioning slot that matches the positioning edge.

In accordance with some embodiments of the present disclosure, a plurality of buckles are formed on the positioning edge, and the inner wall surface of the case has a plurality of clamping slots corresponding to the plurality of buckles.

In accordance with some embodiments of the present disclosure, the card holder further includes an anti-loosening member for increasing a frictional force between the card and the case, and the anti-loosening member is arranged on at least one inner wall surface of the case in left and right directions.

In accordance with some embodiments of the present disclosure, a side of the anti-loosening member that faces the card is a friction surface, and an end of the friction surface that faces the top end of the case forms an arc-shaped guide surface.

In accordance with some embodiments of the present disclosure, the friction surface has a plurality of protrusions integrally manufactured and molded with the anti-loosening member.

Additional aspects and advantages of the present disclosure will be given in part in the description below, and in part will become apparent from the description below, or will be learned through the practice of the present disclosure.

### BRIEF DESCRIPTION OF DRAWINGS

The present disclosure is further described below with reference to the accompanying drawings and embodiments, in which:

FIG. 1 is a schematic structural diagram of a card holder according to an embodiment of the present disclosure;

FIG. 2 is a schematic sectional view of a card holder shown in FIG. 1;

FIG. 3 is an exploded schematic diagram of a card holder shown in FIG. 1;

FIG. 4 is an enlarged schematic diagram of a base, a pushing member, a stepped component and an elastic element in FIG. 3;

FIG. 5 is a schematic structural diagram of a stepped component in FIG. 4;

FIG. 6 is a schematic structural diagram of a pushing member in FIG. 4;

FIG. 7 is a schematic structural diagram of an elastic element in FIG. 4;

FIG. 8 is a schematic top view of a base in FIG. 4;

FIG. 9 is a schematic left view of a base in FIG. 4;

FIG. 10 is a schematic bottom view of a case in FIG. 3; and

FIG. 11 is a schematic structural diagram of an anti-loosening member in FIG. 2.

### REFERENCE NUMERALS

case 100; positioning slot 110; clamping slot 120; anti-loosening member 130; friction surface 131; guide surface 132; protrusion 133;
base 200; through hole 210; right side wall 220; first hole position 230; second baffle 240; notch 241; bottom wall 250; front side wall 260; rear side wall 270; rib 280; support table 290; positioning edge 291; buckle 292;
pushing member 300; limiting mechanism 310; blocking plate 311; second hole position 320; second shaft 330; support lug 340; first baffle 350;
stepped component 400; step 410; chute 420; first arm 430; second arm 440; mounting hole 450;
first shaft 500;
elastic element 600; torsion spring 610; energy storage section 611; first torsion arm 612; second torsion arm 613; first bending portion 614; second bending portion 615.

### DETAILED DESCRIPTION

The embodiment of the present disclosure is described in detail below, the example of the embodiment is shown in the accompanying drawings, and from beginning to end, the same or similar numerals indicate the same or similar elements or elements with same or similar function. The embodiment described with reference to the accompanying drawings is an example which is merely used to explain the present disclosure, instead of being understood as a limitation to the present disclosure.

In the description of the present disclosure, it is understood that orientation or position relationships indicated by the terms “upper”, “lower”, and the like are based on the orientation or position relationships as shown in the accompanying drawings, for ease of describing the present disclosure and simplifying the description only, rather than indicating or implying that the mentioned apparatus or element necessarily has a particular orientation and must be constructed and operated in the particular orientation. Therefore, these terms should not be understood as limitations to the present disclosure.

In the description of the present disclosure, “a plurality of” means two or above two. The described “first” and “second” are merely used for distinguishing technical features, instead of being understood as indicating or implying relative importance or impliedly indicating the quantity of the showed technical features or impliedly indicating the precedence relationship of the showed technical features.

In the description of the present disclosure, unless specific limitation otherwise, terms “arrange”, “mount”, “connect” and the like should be generally understood. Those having ordinary skill in the art may reasonably determine the specific meaning of the terms in the present disclosure in combination with the specific contents of the technical solution.

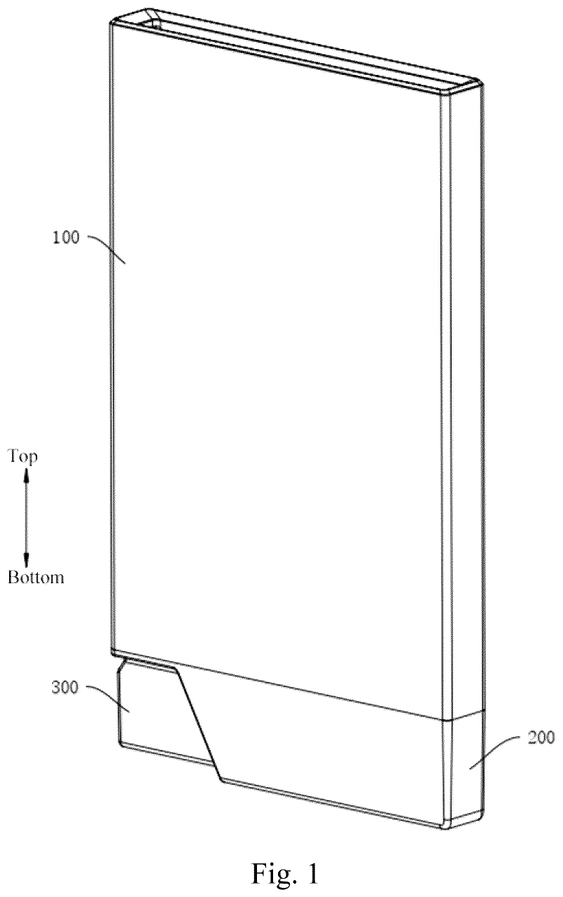

Referring to FIG. 1, a card holder according to an embodiment of the present disclosure is configured to store cards such as bank cards, access cards, ID cards, business cards and so on, and push out multiple cards in a one-by-one manner to allow a user select a required card.

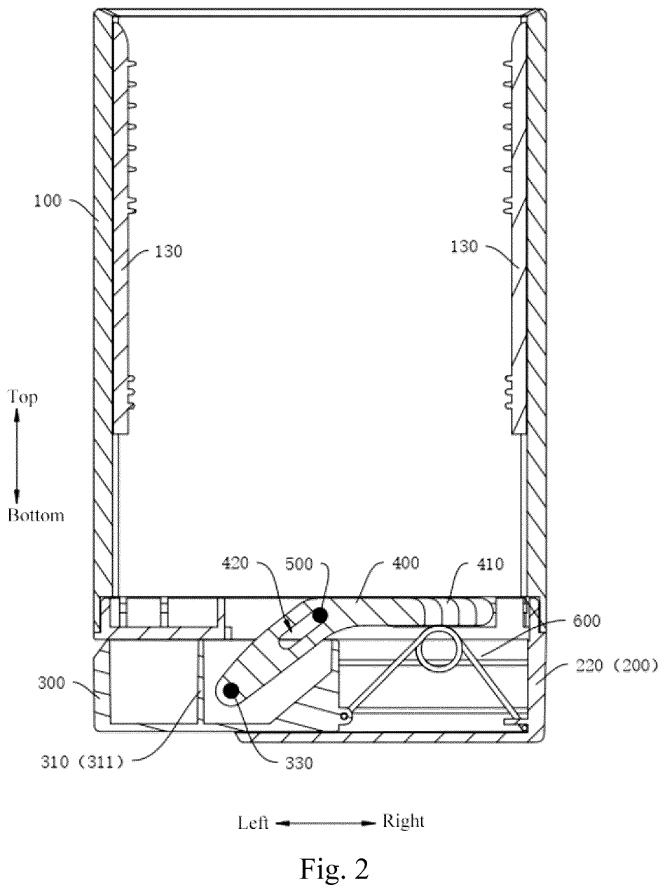

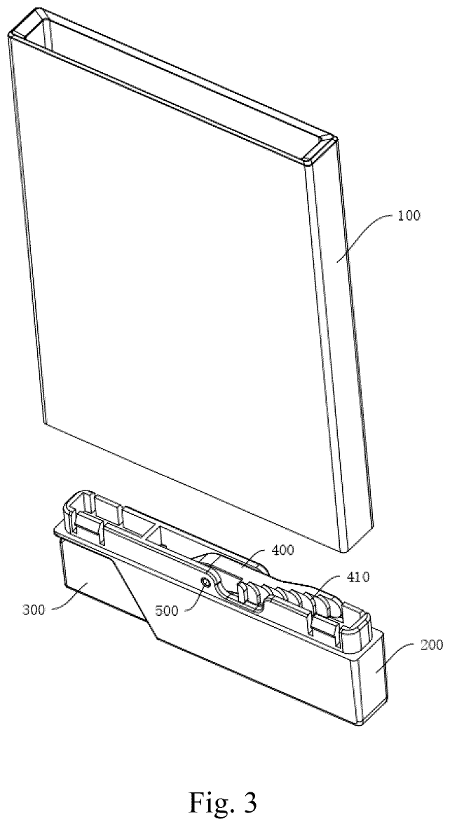

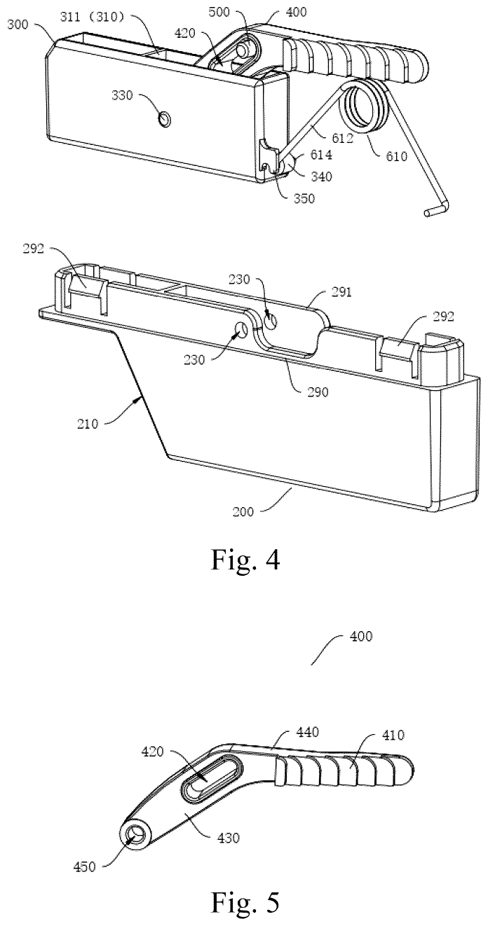

Referring to FIG. 1, FIG. 2 and FIG. 3, the card holder of this embodiment includes a case 100, a base 200, a pushing member 300 and a stepped component 400. A space for stacking one or more cards is formed inside the case 100. An opening through which the cards are pushed out is provided at a top end of the case 100, and a bottom end of the case 100 is connected to the base 200. The base 200 can be fixedly connected to the case 100 by means of a snap connection, a screw connection, or the like. Referring to FIG. 4, a through hole 210 is formed in one side of the base 200, and the other side of the base 200 is a closed right side wall 220. The pushing member 300 is configured to be slidably assembled to the base 200 via the through hole 210. For example, a part of the pushing member 300 is exposed outside the base 200, and another part of the pushing member 300 is inserted into the base 200 through the through hole 210 to slidably cooperate with the base 200. Therefore, a cooperation area between the pushing member 300 and the base 200 can be increased to improve the sliding stability. Moreover, an effective area of the pushing member 300 on which the user applies thrust is also increased to improve the user's operating experience.

Referring to FIG. 2 and FIG. 4, one end of the stepped component 400 is hinged to the pushing member 300, that is, the stepped component 400 can rotate relative to the pushing member 300. The hinge can be realized in many ways, which are not specifically limited here. The other end of the stepped component 400 is a free end which has a step 410 cooperating with a card. A chute 420 in a middle of the stepped component 400 is located between the hinge of the pushing member 300 and the step 410. A first shaft 500 passing through the chute 420 of the stepped component 400 is fixed to the base 200, and the first shaft 500 is configured to be able to slide in the chute 420. Each of a front end and a rear end of the base 200 has a first hole position 230. Both ends of the first shaft 500 are mounted in the two first hole positions 230, respectively. A middle of the first shaft 500 passes through the chute 420, making the assembly of the pushing member 300 and the base 200 convenient.

Referring to FIG. 2 and FIG. 3, when the user applies an acting force to the pushing member 300 in a direction of the base 200, the pushing member 300 slides toward an interior of the base 200 to drive the stepped component 400 to rotate around the pushing member 300, and the chute 420 slides relative to the first shaft 500, such that the step 410 pushes one or more cards out of the opening at the top end of the case 100. A movement cooperation between the pushing member 300, the stepped component 400 and the base 200 of the card holder in this embodiment is stable and reliable, so it can reduce the wear between the pushing member 300 and the base 200 in the sliding process. In addition, the stepped component 400 pushes the card with high precision, and reduces the movement wear between the stepped component 400, the pushing member 300 and the base 200, making the use of the card holder smoother and the durability of the card holder better.

Referring to FIG. 2 and FIG. 4, the card holder of this embodiment further includes an elastic element 600 to achieve sliding reset of the pushing member 300. The elastic element 600 can be mounted in the base 200, and configured to apply a force to reset the pushing member 300 in a sliding direction thereof, such that the stepped component 400 can be reset by the pushing member 300 after the card is pushed out of the case 100 and the user loosens the pushing member 300. This avoids the damage to the stepped component 400 since the card interferes with the step 410 of the stepped component 400 when being pushed back to the case 100 by the user, thus reducing the probability of failure of the stepped component 400.

Referring to FIG. 5, the stepped component 400 includes a first arm 430 and a second arm 440 that are connected to each other. The first arm 430 and the second arm 440 form an obtuse angle. The first arm 430 is hinged to the pushing member 300 at one end along the length direction thereof and is provided with the chute 420 extending in the length direction of the first arm 430 at the other end thereof. The second arm 440 is connected to the first arm 430 at one end along the length direction thereof and is provided with a step 410 at the other end thereof, such that stepped component 400 rotates stably and accurately, and a stepped arrangement of the cards pushed out can be orderly.

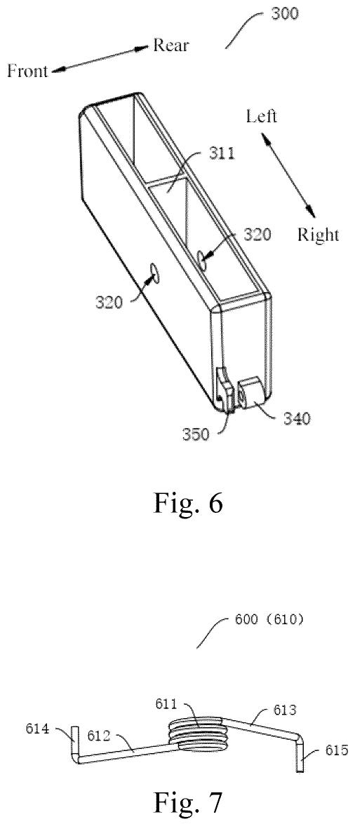

Referring to FIG. 2 and FIG. 6, the pushing member 300 has a limiting mechanism 310 configured to limit a terminal angle of a rotation of the stepped component 400 around the pushing member 300 to prevent the stepped component 400 from exceeding a dead point and being unable to reset. The limiting mechanism 310 is configured to abut against and cooperate with the first arm 430 to limit the stepped component 400 from rotating beyond the dead point.

Referring to FIG. 2 and FIG. 6, the limiting mechanism 310 is a blocking plate 311 formed inside the pushing member 300. The blocking plate 311 can be integrally manufactured and molded with the pushing member 300. The blocking plate 311 is located on a left side of the hinge between the stepped component 400 and the pushing member 300, that is, the side of the hinge that is away from the elastic element 600. The hinge is spaced apart from the blocking plate 311, making the structure of the pushing member 300 compact and stable.

Referring to FIG. 6, the stepped component 400 has a mounting hole 450 formed in the first arm 430. Each of a front end and a rear end of the pushing member 300 has a second hole position 320. The pushing member 300 has a second shaft 330, and both ends of the second shaft 330 are mounted at the two second hole positions 320, respectively. A middle of the second shaft 330 passes through the mounting hole 450, such that the stepped component 400 is hinged to the pushing member 300, thereby achieving a stable rotation between the stepped component 400 and the pushing member 300.

Referring to FIG. 2 and FIG. 7, the elastic element 600 is a torsion spring 610 which includes an energy storage section 611 as well as a first torsion arm 612 and a second torsion arm 613 that are located at both ends of the energy storage section 611. The first torque arm 612 is fixed to the pushing member 300, for example, by plugging, buckling, etc. The second torsion arm 613 is fixed to a side wall of the base 200 away from the through hole 210, that is, the right side wall 220, for example, by means of plugging, buckling, etc. Therefore, the torsion spring 610 can achieve stable installation of the pushing member 300 and the base 200, so as to apply a stable restoring force to the pushing member 300, and has good stability and durability.

Referring to FIG. 4, FIG. 6 and FIG. 7, in order to improve the installation stability of the torsion spring 610 and avoid failure caused by the loosening of the torsion spring 610, the pushing member 300 has a support lug 340. A first bending portion 614 at an end of the first torsion arm 612 is plugged into the support lug 340. In order to prevent the first bending portion 614 from slipping out of the support lug 340, the pushing member 300 also has a first baffle 350. The first torsion arm 612 is clamped between the first baffle 350 and the support lug 340, such that a stable connection is achieved between the first torsion arm 612 and the pushing member 300. In order to improve the structural strength of the support lug 340 and the first baffle 350, the support lug 340 and the first baffle 350 may be integrally manufactured and molded with the pushing element 300.

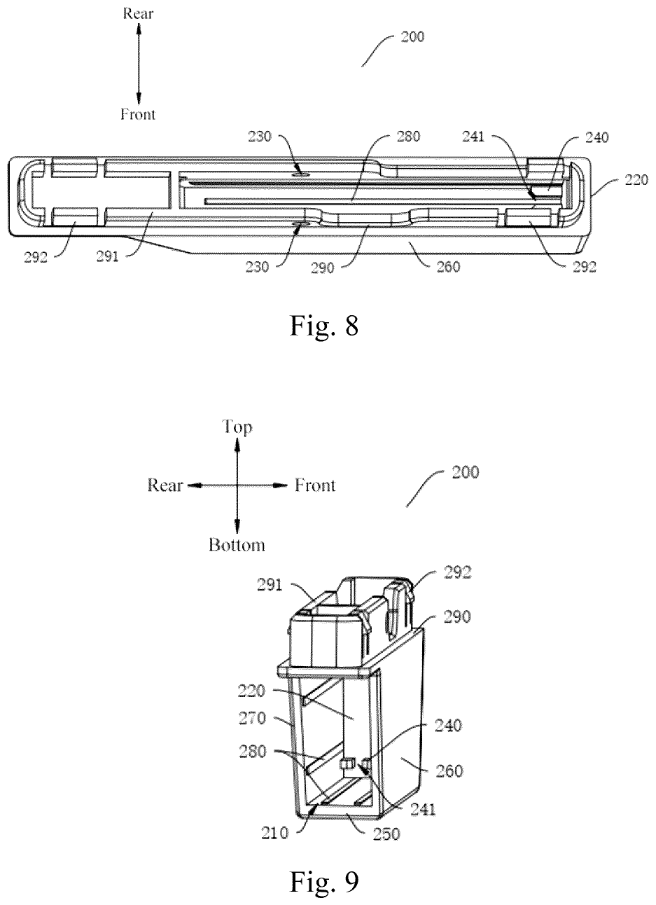

Referring to FIG. 8 and FIG. 9, a second bending portion 615 is provided at an end of the second torsion arm 613, and the base 200 has a second baffle 240 which is parallel to and spaced apart from a bottom wall 250 of the base 200. A notch 241 through which the second torsion arm 613 to pass is provided on the left side of the second baffle 240, and the second bending portion 615 is clamped between the second baffle 240 and the bottom wall 250 of the base 200, thereby achieving a stable connection between the second torsion arm 613 and the base 200. The second baffle 240 may be integrally manufactured and molded with the base 200 to improve a structural strength of the second baffle 240.

For ease of mounting the second torsion arm 613 into the notch 241, the second baffle 240 has a chamfer at an opening end of the notch 241.

Referring to FIG. 8 and FIG. 9, the base 200 includes a bottom wall 250 located at the bottom end, a front side wall 260 located at the front end, and a rear side wall 270 located at the rear end. At least one of an inner wall surface of the bottom wall 250, an inner wall surface of the front side wall 260 and an inner wall surface of the rear side wall 270 has a rib 280, or each of the above-mentioned three inner wall surfaces has the rib 280. The rib 280 is formed by the corresponding inner wall surface protruding toward the inside of the base 200. One inner wall surface may have one or more ribs 280. When one inner wall surface has multiple ribs 280, the multiple ribs 280 are arranged at intervals in the height direction of the base 200. The one or more ribs 280 extend in a sliding direction of the pushing member 300, and the base 200 is slidably connected to an outer wall surface of the pushing member 300 through the ribs 280, thus reducing a contact area between the pushing member 300 and the base 200 and a sliding friction between the pushing member 300 and the base 200, and making the sliding movement of the pushing member 300 stable, reliable, smoother, less worn, and durable. The ribs 280 are integrally manufactured and molded with the base 200 to improve strength and durability of the ribs 280.

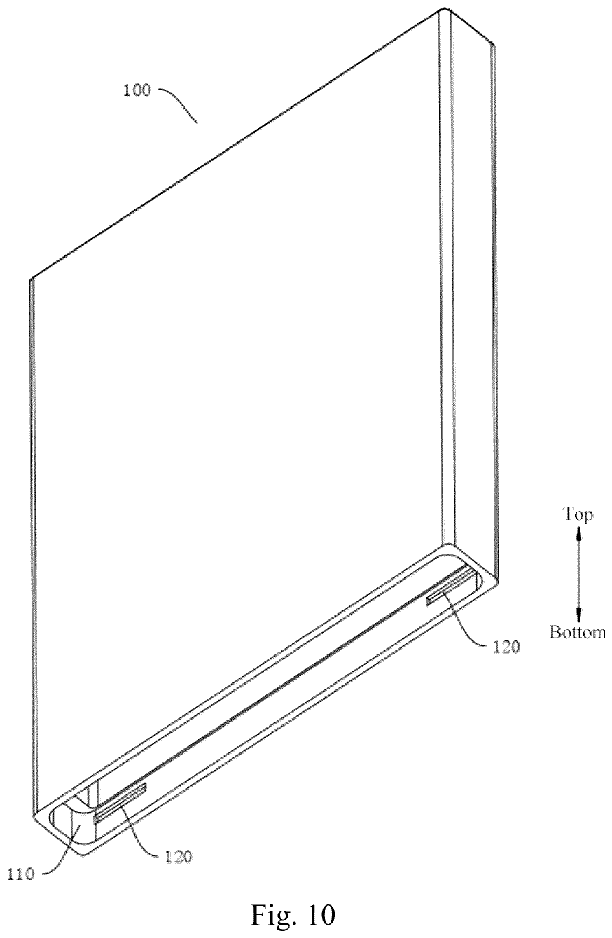

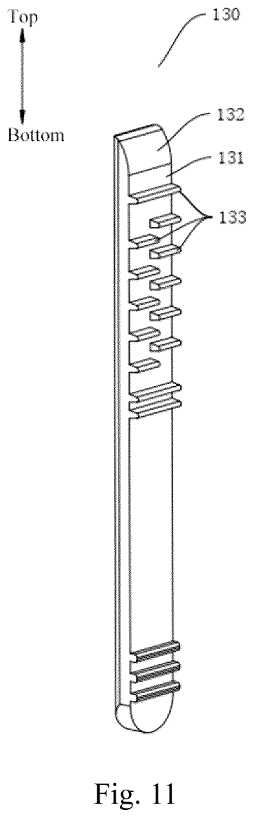

Referring to FIG. 8 and FIG. 10, a support table 290 is arranged at a top end of the base 200, and both front and rear sides of the step 410 abut against and cooperate with the support table 290, respectively, to support the step 410, thereby improving the supporting stability of the step 410 for the card, preventing the step 410 from falling into the base 200 and interfering with components such as the torsion spring 610, and effectively reducing the failure rate of the stepped component 400.

Referring to FIG. 8 and FIG. 10, the base 200 and the case 100 are fixed by clamping, thereby improving the assembly efficiency of the card holder. To achieve stable clamping, the support table 290 has a positioning edge 291 along a circumference thereof, and the inner wall surface of the case 100 has a positioning slot 110 that cooperates with the positioning edge 291, to achieve accurate positioning of the case 100 and the base 200. Referring to FIG. 1, a plurality of buckles 292 are formed on the positioning edge 291, and an inner wall surface of the case 100 has a plurality of clamping slots 120 matching the plurality of buckles 292. The buckles 292 are inserted into the clamping slots 120, thereby achieving a stable connection of the case 100 and the base 200.

Referring to FIG. 2 and FIG. 11, the card holder further includes an anti-loosening member 130 for increasing a frictional force between the card and the case 100. The anti-loosening member 130 may be made of rubber or silicone, or made of felt or other materials. The anti-loosening member 130 is arranged on the inner wall surface of the case 100 along left and right directions. The anti-loosening member 130 may be disposed only on the left wall surface, for example, or only on the right wall surface, or on both the left wall surface and the right wall surface, as long as the card does not fall out of the opening of the case 100 when not pushed out.

Referring to FIG. 11, a side of the anti-loosening member 130 that faces the card is a friction surface 131 which enables the card to be stably stored in the case 100 and to not easily fall out of the opening of the case 100. Moreover, the card can be smoothly pushed out of the case 100 under the action of the stepped component 400. One end of the friction surface 131 that faces the top end of the case 100 forms an arc-shaped guide surface 132, thus reducing the resistance at the opening of the case 100 when the card is pushed out while ensuring a stable connection between the card and the anti-loosening member 130, making the operation of the pushing member 300 smooth.

Referring to FIG. 11, the friction surface 131 has a plurality of protrusions 133 which can undergo elastic deformation, such that the clamping cooperation of the anti-loosening member 130 and the card has a larger adjustment space, ensuring that the number of cards in the case 100 is small or the card is not easy to fall out of the case 100 when it is tilted. The protrusions 133 are integrally manufactured and molded with the anti-loosening member 130, thereby improving an structural strength of the plurality of protrusions 133.

The embodiment of the present disclosure is described in detail above in combination with the accompanying drawings, and however the present disclosure is not limited the above embodiment. Under the premise of not departing from the gist of the present disclosure, various changes may also be made within the knowledge scope of those skilled in the art.

1. A card holder, comprising:
a case, inside which a space for stacking one or more cards is formed;
a base connected to a bottom end of the case, a through hole being formed in one side of the base;
a pushing member configured to be slidably assembled to the base via the through hole;
an elastic element capable of exerting a force to reset the pushing member in a sliding direction of the pushing member;
a stepped component hinged to the pushing member at one end of the stepped component, a step cooperating with the card being arranged on the other end of the stepped component, a chute being arranged in a middle of the stepped component and throughout a direction perpendicular to the sliding direction;
a first shaft passing through an interior of the chute and fixed to the base;
wherein in response to the pushing member sliding toward an interior of the base, the stepped component rotates around the pushing member under a constraint of a relative sliding cooperation between the chute and the first shaft, such that the step pushes one or more cards out of a top end of the case.

2. The card holder according to claim 1, wherein the stepped component comprises a first arm and a second arm that are connected to each other to form an obtuse angle at a joint of the first arm and the second arm, the first arm is hinged to the pushing member at one end of the first arm, the chute located at the other end of the first arm extends in a length direction of the first arm, the second arm is connected to the first arm at one end of the second arm, and the step is located at the other end of the second arm.

3. The card holder according to claim 2, wherein the pushing member comprises a limiting mechanism configured to abut against and cooperate with the first arm to limit a terminal angle of a rotation of the stepped component around the pushing member.

4. The card holder according to claim 3, wherein the limiting mechanism is a blocking plate arranged inside the pushing member, a hinge between the stepped component and the pushing member is spaced apart from the blocking plate; the blocking plate is located on one side of the hinge that is away from the elastic element, and configured to limit the rotation of the stepped component when the stepped component is at the position of the terminal angle.

5. The card holder according to claim 1, wherein the stepped component comprises a mounting hole throughout a direction perpendicular to the sliding direction, and the pushing member comprises a second shaft which passes through the mounting hole, such that the stepped component is hinged to the pushing member.

6. The card holder according to claim 1, wherein the elastic element is a torsion spring comprising a first torsion arm fixed to the pushing member, and a second torsion arm fixedly connected to a side wall of the base that is away from the through hole.

7. The card holder according to claim 6, wherein the first torsion arm comprises a first bending portion at an end of the first torsion arm, and the pushing member comprises a support lug into which the first bending portion is plugged, and a first baffle, such that the first torsion arm is clamped between the first baffle and the support lug.

8. The card holder according to claim 6, wherein the second torsion arm comprises a second bending portion at an end of, and the base comprises a second baffle with a notch through which the second torsion arm passes, such that the second bending portion is clamped between the second baffle and a bottom wall of the base.

9. The card holder according to claim 1, wherein the base comprises a bottom wall, a front side wall and a rear side wall; each of an inner wall surface of the bottom wall, an inner wall surface of the front side wall and an inner wall surface of the rear side wall comprises a rib extending in the sliding direction of the pushing member, such that the base is slidably connected to an outer wall surface of the pushing member through the rib.

10. The card holder according to claim 1, wherein the base comprises a support table at a top end of the base, and a front side and a rear side of the step abut against and cooperate with the support table, respectively.

11. The card holder according to claim 10, wherein the support table comprises a positioning edge along a circumference of the support table, and the inner wall surface of the case comprises a positioning slot that matches the positioning edge.

12. The card holder according to claim 11, wherein the positioning edge comprises a plurality of buckles, and the inner wall surface of the case comprises a plurality of clamping slots corresponding to the plurality of buckles.

13. The card holder according to claim 1, wherein the card holder further comprises an anti-loosening member for increasing a frictional force between the card and the case; and the anti-loosening member is arranged on at least one inner wall surface of the case in a horizontal direction.

14. The card holder according to claim 13, wherein a side of the anti-loosening member that faces the card is a friction surface, and an end of the friction surface that faces the top end of the case forms an arc-shaped guide surface.

15. The card holder according to claim 14, wherein the friction surface comprises a plurality of protrusions which are integrally manufactured and molded with the anti-loosening member.
